(19) United States
(12) Patent Application Publication
(10) Pub. No.: US 2002/0047488 A1
(43) Pub. Date: Apr. 25, 2002

(54) POWDER COATED INSULATED BOLTS

(76) Inventors: SCOT ADAMS WEBB, GALES FERRY, CT (US); STEVEN CHARLES WALKO, CLIFTON PARK, NY (US); ROBERT JOSEPH PEAT, TROY, NY (US); PATRICIA CHAPMAN IRWIN, ALTAMONT, NY (US)

Correspondence Address: MICHAEL J KEENAN, NIXON & VANDERHYE PC, 1100 NORTH GLEBE ROAD 8TH FLOOR, ARLINGTON, VA, 222014714

(21) Appl. No.: 09/430,904

(22) Filed: Nov. 1, 1999

(51) Int. Cl. H02K 5/00

(52) U.S. Cl. 310/273

(57) ABSTRACT

A bolt intended to carry structural loads, such as but not limited to in pressure vessels or electrical machinery, that is electrically insulated from the clamped structure by a powder coating on the underside of the head and shank of the bolt.

### BACKGROUND OF THE INVENTION

This invention relates to insulated bolts, particularly for use in large turbine generators.

Rotating electromagnetic machines require a magnetic field to move relative to the current carrying conductors in the machine armature. A traditional generator includes a rotating field which consists of an even numbered plurality of magnetic poles. The rotating magnetic field associated with the machine rotor causes magnetic flux to travel past the conductors, which are generally in the form of multiple coils mounted in slots provided in the ferromagnetic armature core. Current then flows in the conductors, in accordance with Lenz's Law, to produce an electromotive force opposing the rotor flux. In an ideal machine, all resistances and reluctances are uniform and symmetrical, and the flux field generated by the rotor lies generally in a radial-tangential plane. However, an actual machine is neither ideally symmetric nor uniform due to variations in manufacturing and assembly processes and in material properties. This non-uniformity causes the flux field to become three dimensional, which in turn can cause electrical current to flow axially in the rotor and the armature or generator frame. As this current flows from the rotor to the stator through the small gaps adjacent to the bearings and seals, it can cause arcing and pitting of the surfaces of these components. Pitting can cause premature failure of the bearings, seals, and rotor shaft.

Current will not flow absent a continuous conductive path. Hence, the path is broken by providing electrical insulation between the bearing and the endshield, and between the hydrogen seal casing and the endshield at one end of the generator.

The traditional method of creating insulated bolts in large turbine generators has been to apply cured-in-place fiberglass and epoxy on the shank, and to install a nonconductive insulation washer under the head of the bolt. The usual application also includes a metal washer under the bolt head to prevent cracking of the insulation washer. In some applications, the bolt shank is undercut to limit the maximum built up shank diameter to that of the original bolt.

A variation of this design that reduces the number of parts includes a bolt with an integral washer forged with the head, known as a flange headed bolt. A further variation is to use insulating sleeving on the shank instead of the epoxy—fiberglass coating. This eliminates the expense and time needed to apply and cure the coating.

The electronics industry solves a similar problem on a smaller scale by using a shoulder washer to insulate the fasteners used for mounting semiconductors to heatsinks on printed wiring boards. Others have also used nonconductive fasteners as an alternative to adding insulation to otherwise conductive fasteners.

### BRIEF SUMMARY OF THE INVENTION

In an exemplary embodiment of this invention, an electrically insulating coating is applied on the fastener shank and on the underside of the bolt head. The coating must withstand the rigors of operation in service including, but not limited to temperature, chemical exposure, clamping load, electrical stress and vibration. Further, the coating must be robust to the rigors encountered prior to service, such as handling, shipping, storage and assembly processes.

Considering the environmental factors present, an epoxy powder or a variant thereof for the coating would be expected to conform to all of the service requirements. However, it is not the intent of this invention to limit the coating material selection. Product research indicates that epoxy powder coatings have been used in the electrical industry for many years for both electrical insulation and for mechanical and corrosion protection. As such, these coatings are commercially available with a mature understanding of application processes, physical properties, and behavior in aggressive environments.

As mentioned above, the bolt itself is a flange head bolt, and the epoxy powder coating extends along the threaded shank to at least the underside of the flanged head. The extent of the coating must be such that the necessary electrical insulation requirements such as arcing and creepage are considered.

The invention described herein thus combines the four components of the traditional insulated bolt assembly: the fastener, the metal washer, the insulating washer, and the shank coating into a single component, i.e., a powder coated, integral flange head bolt.

In its broader aspects, the invention relates to an insulated bolt having a head and a threaded shank, at least an upper portion of the shank coated with an insulating powder composition.

In another aspect, the invention relates to a rotating electrical machine assembly comprising a seal casing and an endshield, wherein the seal casing and the endshield are secured by a plurality of electrically insulated bolts, each bolt having a head with an integral flange and a threaded shank, upper portion of the shank and an underside of the integral flange coated with an epoxy powder composition. In another respect, the invention applies to any general rotating electrical machine in which the shaft is insulated from the stator by means of insulating the endshield from the stator frame, in which the bolts securing the endshield to the stator frame must not be electrically conductive.

### BRIEF DESCRIPTION OF THE DRAWINGS

FIG. 1 is a perspective view of a powder coated, insulated bolt in accordance with an exemplary embodiment of the invention;

FIG. 2 is a partial side section illustrating the bolt of claim 1 connecting a hydrogen seal casing and an endshield; and

FIG. 3 is a side cross-section showing the bolt 10 in a configuration used for torque tests.

### DETAILED DESCRIPTION OF THE INVENTION

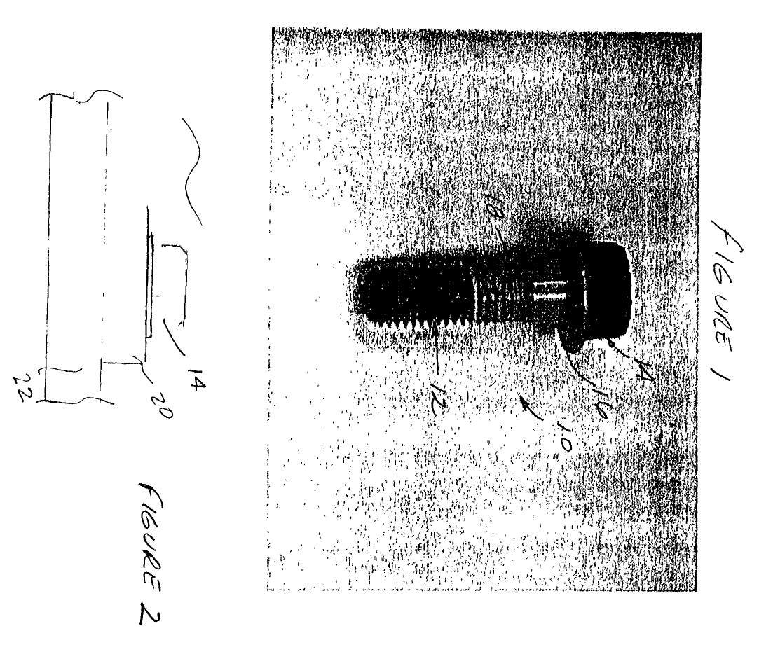

With reference to FIG. 1, the bolt 10 includes a threaded shank 12 and head 14, the latter having an integral flange 16 at the interface with the shank 12. An insulating powder composition in the form of a coating 18 extends from approximately midway along the threaded shank to the flanged head. The coating is shown to cover at least the entire underside of the flange 16, but it will be understood that the coating may extend over the upper side of the flange as well if so desired.

The coating may be any powder composition suitable for the service environment. One such material is sold commercially under the name Scotchcast 5230. The coating is applied in accordance with known powder coating practices to a preferred thickness of about 0.004 to 0.014 in.

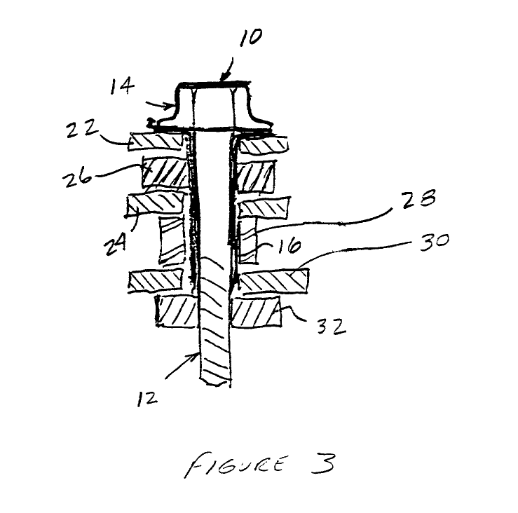

A typical application for the bolts 10 is a generator, with a plurality of bolts 10 (one shown) connecting a hydrogen seal casing 20 and an endshield 22 (partially shown in FIG. 2). A typical required assembly torque for the hydrogen seal casing bolts is 100 ft.-lb., with no lubrication on the threads.

A plurality of bolts 10 as described above were tested by tightening them to a final torque of 250 ft.-lb., in 25 ft.-lb. increments, starting at 50 ft.-lb. The tightening/test fixture is shown in FIG. 3. The test configuration (from the head 14 toward the free end of the shank 12) included a pair of steel washers 22, 24 sandwiched about an insulating spacer 26; a steel spacer 28; another steel washer 30 and a nut 32. This configuration was used only for testing. The only components required in actual use are the bolts as described herein.

Between increments of torque, each bolt 10 was removed and examined for signs of scuffing, cracking and spalling of the coating. The coating on each showed evidence that it had been exercised, but no obvious indications of failure or severe distress were visible. In fact, it appeared that the most rigorous events in the life of the fastener will be during installation and maintenance.

Following the torque test, an electrical test was performed on one of the bolts. The assembly was torqued to 200 ft.-lb, and electrical leads were attached to the steel washers 22, 24 adjacent to the insulating washer 26. DC potential was applied at values of 500, 1000, 2500, and 5000 VDC. The assembly had resistances greater than 100,000 megohms for 1 minute up to 2500 VDC. The insulation failed only at the 5000 VDC test condition. The typical test potential as installed in the endshield assembly is 500 VDC, indicating that the powder coating exceeds the test requirement by a margin of greater than 4. Further, the typical potential during operation of the generator is less than 50 VDC.

The insulated bolt as described is intended to be used to electrically insulate the hydrogen seal casing from the endshield in the assignee's generators, but the insulated bolts can be used to replace traditional insulated bolt assemblies in any application. The invention also not only reduces the number of parts required for the insulated bolt assembly, but also reduces cost.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An electrically insulated bolt having a head and a threaded shank, with the underside of the bolt head and some portion of said shank having an electrically insulating powder composition coating applied thereto.

2. The electrically insulated bolt of claim 1 wherein said coating has a thickness of about 0.004 to about 0.014 in.

3. The electrically insulated bolt of claim 1 wherein said coating remains functional fully tightened and at an electrical potential of about 5000 VDC.

4. A generator assembly comprising a seal casing and an endshield, wherein said seal casing and said endshield are secured by a plurality of electrically insulated bolts, each bolt having a head with an integral flange and a threaded shank, with some portion of said shank and the underside of said integral flange having an electrically insulating powder composition coating applied thereto.

5. The assembly of claim 4 wherein said coating has a thickness of about 0.004 to about 0.014 in.

6. The assembly of claim 4 wherein said coating remains functional fully tightened and at an electrical potential of about 5000 VDC.
